(19) United States
(12) Patent Application Publication
(10) Pub. No.: US 2023/0075932 A1
(43) Pub. Date: Mar. 9, 2023

(54) DYNAMIC VARIABLE QUANTIZATION OF MACHINE LEARNING PARAMETERS

(71) Applicant: VIANAI SYSTEMS, INC., Palo Alto, CA (US)

(72) Inventors: Vishal Inder SIKKA, Los Altos Hills, CA (US); Srikar SRINATH, Palo Alto, CA (US)

(21) Appl. No.: 17/517,505

(22) Filed: Nov. 2, 2021

Related U.S. Application Data
(60) Provisional application No. 63/240,587, filed on Sep. 3, 2021.

(51) Int. Cl. G06N 3/08; G06K 9/62; G06F 1/03

(52) U.S. Cl. CPC G06N 3/082; G06K 9/6201; G06K 9/6227; G06K 9/6262; G06F 1/03

(57) ABSTRACT

One embodiment of the present invention sets forth a technique for quantizing a machine learning model. The technique includes selecting a default quantized version of the machine learning model based on a plurality of performance metrics for a plurality of quantized versions of the machine learning model. The technique also includes determining that a first output generated by the default quantized version based on a first set of feature values does not match a second output associated with the first set of feature values. The technique further includes storing a first mapping of one or more first feature values included in the first set of feature values to a first quantized version of the machine learning model in a lookup table representing the machine learning model, wherein the first quantized version is associated with a higher quantization resolution than the default quantized version.

### CROSS-REFERENCE TO RELATED APPLICATIONS

This application claims benefit of United States Provisional Patent Application titled “Dynamic Variable Quantization of Machine Learning Inputs,” filed Sep. 3, 2021 and having Ser. No. 63/240,587. The subject matter of this related application is hereby incorporated herein by reference.

### BACKGROUND

Field of the Various Embodiments

The various embodiments relate generally to computer science and machine learning and, more specifically, to dynamic variable quantization of machine learning parameters.

### DESCRIPTION OF THE RELATED ART

Non-quantized machine learning models are commonly trained to generate or predict classes, numeric values, images, audio, text, and/or other types of attributes. For example, non-quantized neural networks use floating point numbers to represent inputs, weights, activations, or the like to achieve high accuracy in the resulting computations. As these non-quantized machine learning models grow in size and complexity, the non-quantized machine learning models require increasing amounts of power, computational resources (e.g., storage, working memory, cache, processor speed, or the like), network bandwidth (e.g., for transferring model to device, updating model), or latency to execute. These requirements limit the ability to use the machine learning models in applications implemented on devices with limited memory, power consumption, network bandwidth, computational capabilities, or the like.

Various compression techniques have been developed to adapt the use of machine learning models to a wider range of devices, hardware platforms, or the like. For example, a neural network can be quantized to use lower precision numbers (e.g., integers) when performing computations, thereby requiring less power consumption, computation capabilities, network bandwidth, and processing time.

However, many hurdles prevent quantized neural networks and other compressed machine learning models from achieving accuracy that is within a reasonable range of non-quantized versions of the same machine learning models. One such hurdle relates to determining the type of quantization or compression scheme to apply to a given machine learning model. While attempts have been made to address this issue, conventional techniques typically apply the same quantization or compression scheme to all machine learning models of a given type (e.g., neural networks). Consequently, the quantized or compressed machine learning models tend to perform poorly relative to their non-quantized or uncompressed counterparts.

Another such hurdle relates to the appropriate amount of quantization or compression to apply to a machine learning model. An increase in the amount of quantization reduces the memory footprint and computational overhead of the machine learning model but can also reduce the accuracy of the machine learning model. Further, the effect of a given amount of quantization on the performance of the machine learning model can vary for different combinations of input values. For example, a neural network could be quantized more heavily without impacting the accuracy of the neural network for certain input values and/or combinations of input values. Conversely, even a small amount of quantization in the neural network may adversely impact the accuracy of the neural network for other input values and/or combinations of input values.

As the foregoing illustrates, what is needed in the art are techniques for balancing the compression of machine learning models with the accuracy, resource overhead, or other measures of performance related to the compressed machine learning models.

### SUMMARY

One embodiment of the present invention sets forth a technique for quantizing a machine learning model. The technique includes selecting a default quantized version of the machine learning model based on a plurality of performance metrics for a plurality of quantized versions of the machine learning model. The technique also includes determining that a first output generated by the default quantized version based on a first set of feature values does not match a second output associated with the first set of feature values. The technique further includes storing a first mapping of one or more first feature values included in the first set of feature values to a first quantized version of the machine learning model in a lookup table representing the machine learning model, wherein the first quantized version is associated with a higher quantization resolution than the default quantized version.

One technical advantage of the disclosed techniques relative to the prior art is that the memory footprint, inference speed, and computational overhead of the machine learning model is reduced without impacting the accuracy of the machine learning model. Another advantage of the disclosed techniques is the ability to adapt the quantization of the machine learning model to different numbers and/or types of features, target values to be predicted from the features, target hardware platforms, and/or latency requirements. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 includes more detailed illustrations of the input quantization engine, model quantization engine, and inference engine of FIG. 1, according to various embodiments.

FIG. 3A illustrates an example lookup table generated by the input quantization engine of FIG. 1, according to various embodiments.

FIG. 3B illustrates an example lookup table generated by the input quantization engine of FIG. 1, according to various embodiments.

FIG. 4A illustrates an example lookup table generated by the model quantization engine of FIG. 1, according to various embodiments.

FIG. 4B illustrates an example lookup table generated by the model quantization engine of FIG. 1, according to various embodiments.

FIG. 5 sets forth a flow diagram of method steps for quantizing inputs into a machine learning model, according to various embodiments.

FIG. 6 sets forth a flow diagram of method steps for quantizing a machine learning model, according to various embodiments.

FIG. 7 sets forth a flow diagram of method steps for performing inference related to a machine learning model, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

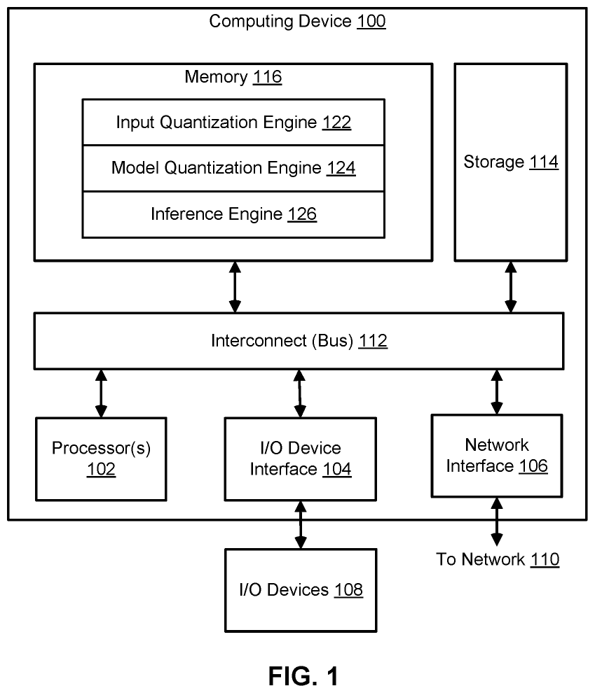

FIG. 1 illustrates a computing device 100 configured to implement one or more aspects of the present invention. Computing device 100 may be a desktop computer, a laptop computer, a smart phone, a personal digital assistant (PDA), tablet computer, server computer, or any other type of computing device configured to receive input, process data, and optionally display images, and is suitable for practicing one or more embodiments of the present invention. Computing device 100 is configured to run an input quantization engine 122, a model quantization engine 124, and an inference engine 126 that reside in a memory 116.

It is noted that computing device 100 described herein is illustrative and that any other technically feasible configurations fall within the scope of the present invention. For example, multiple instances of input quantization engine 122, model quantization engine 124, and inference engine 126 could execute on a set of nodes in a data center, cluster, or cloud computing environment to implement the functionality of computing device 100. In another example, input quantization engine 122, model quantization engine 124, and inference engine 126 could be implemented together and/or separately using one or more hardware and/or software components or layers.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

In one embodiment, I/O devices 108 include devices capable of receiving input, such as a keyboard, a mouse, a touchpad, and/or a microphone, as well as devices capable of providing output, such as a display device and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and external entities or devices, such as a web server or another networked computing device. For example, network 110 could include a wide area network (WAN), a local area network (LAN), a wireless (WiFi) network, and/or the Internet, among others.

In one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Input quantization engine 122, model quantization engine 124, and inference engine 126 may be stored in storage 114 and loaded into memory 116 when executed.

In one embodiment, memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including input quantization engine 122, model quantization engine 124, and inference engine 126.

Input quantization engine 122, model quantization engine 124, and inference engine 126 include functionality to perform dynamic variable quantization of inputs, weights, biases, activations, and/or other components of a neural network and/or another type of machine learning model. As described in further detail below, dynamic variable quantization includes adjusting the amount of quantization applied to subsets or combinations of these components of the machine learning model based on the accuracy or other metrics related to the machine learning model before and after quantization; thresholds for the accuracy, memory footprint, or computational overhead associated with the machine learning model; and/or other factors. As a result, the machine learning model can be quantized in a way that reduces resource consumption associated with performing inference using the machine learning model without significantly impacting the accuracy of the machine learning model.

### Dynamic Variable Quantization of Machine Learning Models

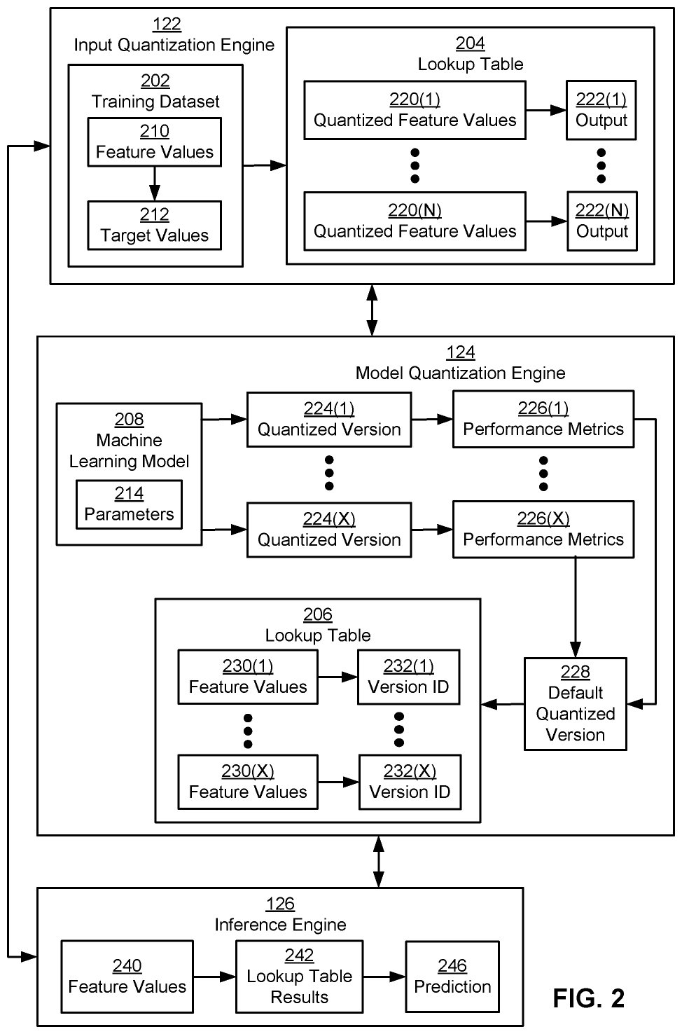

FIG. 2 includes more detailed illustrations of input quantization engine 122, model quantization engine 124, and inference engine 126 of FIG. 1, according to various embodiments. As mentioned above, input quantization engine 122, model quantization engine 124, and inference engine 126 are configured to selectively quantize inputs, parameters 214, and/or other components that affect the operation of a machine learning model 208.

In one or more embodiments, machine learning model 208 includes a set of parameters 214 that are learned during training of machine learning model 208. For example, machine learning model 208 could include one or more recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (GANs), variational autoencoders (VAEs), self-organizing maps (SOMs), and/or other types of artificial neural networks or components of artificial neural networks. Each artificial neural network could include a set of weights, biases, and/or activations that affect the processing performed by the artificial neural network on a given input or set of inputs.

Machine learning model 208 may also, or instead, include other types of machine learning components. For example, machine learning model 208 could include a regression model, support vector machine, decision tree, random forest, gradient boosted tree, naïve Bayes classifier, Bayesian network, hierarchical model, and/or ensemble model.

In some embodiments, machine learning model 208 is trained to predict target values 212 in a training dataset 202, given corresponding sets of feature values 210 for one or more features inputted into machine learning model 208. For example, machine learning model 208 could be trained to predict a label that includes one or more classes or categories to which an entity belongs, given a corresponding set of feature values 210 associated with the entity. In another example, machine learning model 208 could be trained to predict a temperature, height, price, or another numeric target value of a dependent variable, given feature values 210 that are correlated with the target value. In both examples, feature values 210, target values 212, and components of machine learning model 208 could be represented before, during, and/or after training using single-precision, double-precision, and/or other types of “full-precision” floating point numbers.

As shown in FIG. 2, input quantization engine 122 performs dynamic variable quantization of feature values 210 in training dataset 202 (and/or another dataset with feature values 210 and/or target values 212 related to machine learning model 208). During this dynamic variable quantization of feature values 210, input quantization engine 122 generates a lookup table 204 that represents machine learning model 208. Lookup table 204 includes mappings between multiple sets of quantized feature values 220(1)-(N) and corresponding outputs 222(1)-(N) of machine learning model 208. Consequently, mappings in lookup table 204 can be used to represent the operation of machine learning model 208 in generating outputs 222 from corresponding sets of feature values 210.

To generate lookup table 204, input quantization engine 122 initially converts each set of full-precision feature values 210 in training dataset 202 (and/or another dataset with feature values 210 and/or target values 212) into a set of quantized feature values 220 at a low quantization resolution (i.e., a low number of quantization levels). Input quantization engine 122 inputs each set of quantized feature values 220 into machine learning model 208 and compares the prediction produced by machine learning model 208 from the inputted quantized feature values 220 to a corresponding target value from training dataset 202 and/or the prediction produced by machine learning model 208 from the corresponding unquantized set of feature values 210 in training dataset 202. When the prediction generated by machine learning model 208 from a set of quantized feature values 220 differs or deviates beyond a threshold from the prediction generated by machine learning model 208 from the corresponding unquantized feature values 210 and/or the corresponding target value, input quantization engine 122 repeats the process with a different set of quantized feature values 220 that includes one or more feature values quantized at a higher quantization resolution (i.e., a larger number of quantization levels). Thus, input quantization engine 122 finds the lowest quantization resolution that can be applied to individual feature values 210 and/or a given set of feature values 210 to produce a “correct” output (i.e., an output that is the same as or within a threshold of the output generated by machine learning model 208 from the unquantized feature values 210 and/or a target value for the unquantized feature values 210).

In one or more embodiments, quantization resolution refers to the number of bits (or another unit of data) used to represent quantized values into which an unquantized value is converted. Similarly, the number of quantization levels used to quantize a value refers to the number of discrete quantized values into which a range of unquantized values can be divided. In a first example, an unquantized value that is represented using single-precision, double-precision, or another type of “full-precision” floating-point number can be converted into a quantized value with an eight-bit quantization resolution. Using this eight-bit quantization resolution, the unquantized value can be represented using one of 256 possible quantization levels. In a second example, a full-precision unquantized value can be converted into a quantized value with a three-bit quantization resolution, which is lower than the eight-bit quantization resolution of the first example. Using this three-bit quantization resolution, the unquantized value can be represented using one of eight possible quantization levels.

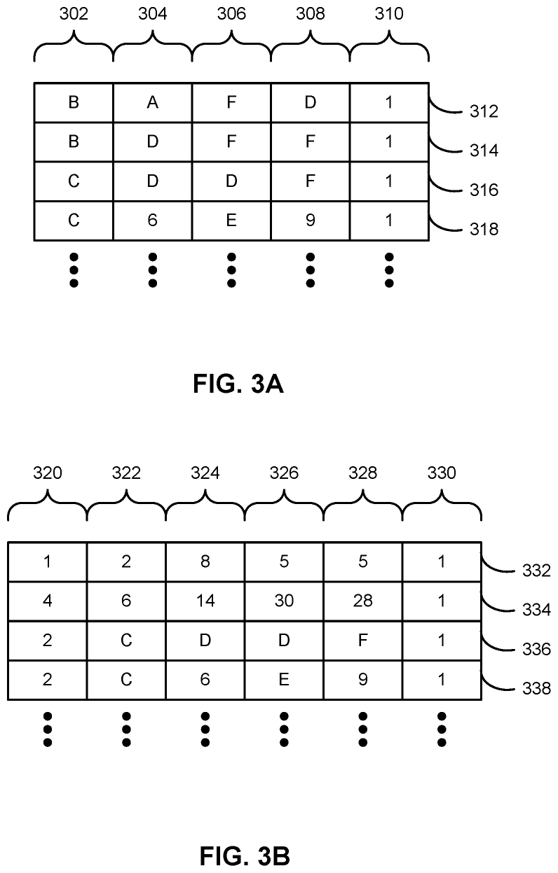

After input quantization engine 122 identifies the lowest quantization resolution and/or number of quantization levels that can be applied to a given set of feature values 210 to produce the “correct” output, input quantization engine 122 stores, in lookup table 204, a mapping between quantized feature values 220 generated from feature values 210 at that quantization resolution and the corresponding output 222. The mapping thus represents the operation of machine learning model 208 in generating output 222 from the quantized feature values 220. Mappings in lookup table 204 are described in further detail below with respect to FIGS. 3A-3B.

For example, machine learning model 208 could include a neural network that is trained to generate a value between 0 and 1 that represents a likelihood of atherosclerosis, given unquantized (e.g., full-precision) features that represent age, gender, body mass index (BMI), blood pressure, cholesterol levels, tobacco smoking, and/or insulin resistance for a patient. Training dataset 202 for the neural network could include hundreds to thousands of rows, where each row includes unquantized feature values 210 for the features and a label of 0 (representing no atherosclerosis) or 1 (representing atherosclerosis) for a corresponding patient. Input quantization engine 122 could initially represent each of the features using two quantized values, with one quantized value for a given feature representing a first half of unquantized feature values 210 for each feature in training dataset 202 (e.g., unquantized feature values 210 from the minimum value for the feature up to the median value for the feature) and a second quantized value for the feature representing a second half of unquantized feature values 210 for the feature in training dataset 202 (e.g., unquantized feature values 210 from the median value for the feature up to the maximum value for the feature). Input quantization engine 122 inputs quantized feature values 220 for each row of training dataset 202 into the trained neural network and compares the prediction generated by the neural network from quantized feature values 220 with the label for the same row (or the prediction generated by the neural network from unquantized feature values 210 for the row). When the prediction generated by the neural network from quantized feature values 220 does not match the label (or the prediction generated by the neural network from unquantized feature values 210) for a given row, the resolution of quantized feature values 220 in the row is adaptively increased (e.g., by a factor of 2, a number of bits or bytes, or another pre-specified increment) until the prediction from the neural network output matches the label for the row (or the prediction generated by the neural network from unquantized feature values 210 for the row).

Continuing with the above example, after all rows of training dataset 202 have been quantized to the lowest quantization resolutions that allow the prediction from the neural network to match the output generated by the neural network from unquantized feature values 210 and/or the corresponding target values 212, input quantization engine 122 could populate lookup table 204 with the variably quantized feature values 220 and the corresponding output 222. Each entry in lookup table 204 could include a set of quantized feature values 220 for the features, as well as the target value or prediction associated with the set of quantized feature values 220. Consequently, in this example, lookup table 204 would be used to map various sets of quantized feature values 210 in training dataset 202 to the corresponding atherosclerosis-based outcomes.

In some embodiments, input quantization engine 122 includes functionality to quantize feature values 210 for different features inputted into machine learning model 208 at different quantization resolutions, in lieu of or in addition to quantizing feature values 210 in different rows of training dataset 202 at different quantization resolutions. In other words, input quantization engine 122 could perform column-based quantization of feature values 210 for different features in training dataset 202. During this column-based quantization, input quantization engine 122 initially converts full-precision feature values 210 for each feature in training dataset 202 (and/or another dataset with feature values 210 and/or target values 212) into a set of quantized feature values 220 at a low quantization resolution (i.e., a low number of quantization levels). Input quantization engine 122 also iterates over individual features inputted into machine learning model 208 to select a quantization resolution for each feature. For example, input quantization engine 122 could input quantized feature values 220 for the feature, along with unquantized feature values 210 for other features, into machine learning model 208. Input quantization engine 122 could also compare the performance of machine learning model 208 in predicting target values 212 from the mix of quantized and unquantized feature values with the performance of machine learning model 208 in predicting target values 212 from only unquantized feature values 210 in training dataset 202. When the predictive performance of machine learning model 208 from the mix of quantized and unquantized feature values is lower than an absolute threshold and/or a threshold that is relative to the predictive performance of machine learning model 208 from the unquantized feature values 210, input quantization engine 122 could repeat the process with quantized feature values 220 of the feature that have been quantized at a higher quantization resolution (i.e., a larger number of quantization levels).

Thus, input quantization engine 122 identifies the lowest quantization resolution that can be applied to feature values 210 for each feature to produce an acceptable level of predictive performance in machine learning model 208. After input quantization engine 122 has selected a quantization resolution to be applied to each feature inputted into machine learning model 208, input quantization engine 122 generates lookup table 204 so that quantized feature values 220 in lookup table 204 are quantized at the corresponding per-feature quantization resolutions. Input quantization engine 122 can additionally store indications of the quantization resolutions associated with individual features in metadata for lookup table 204 to allow other components to parse and/or interpret mappings of quantized feature values 220 to output 222 in lookup table 204.

Input quantization engine 122 can further store, in lookup table 204, mappings of both row-based and column-based quantized feature values 220 to outputs 222. For example, input quantization engine 122 could select a “default” quantization resolution for each feature inputted into machine learning model 208. Input quantization engine 122 could store, in lookup table 204, a first set mappings that include quantized feature values 220 quantized at the default quantized resolutions and corresponding outputs 222. Input quantization engine 122 could also store, in lookup table 204, a second set of mappings that includes quantized feature values 220 that are quantized at resolutions that differ from the corresponding default quantized resolutions. The second set of mappings could represent variations in the lowest quantization resolutions that can be applied to individual rows of feature values 210 in training dataset 202 to produce a “correct” output 222. Input quantization engine 122 could further store indications of the default per-feature quantization resolutions associated the first set of mappings, as well as indications of the quantization resolutions associated with individual quantized feature values 220 and/or rows of quantized feature values 220 in the second set of mappings.

In one or more embodiments, input quantization engine 122 and/or another component determine measures of uncertainty related to individual quantized feature values 220 and/or outputs 222 in lookup table 204. The component also stores these measures of uncertainty with the corresponding mappings in lookup table 204 to allow these measures to be retrieved during subsequent lookup and/or use of mappings in lookup table 204 (e.g., as a proxy for the operation of machine learning model 208 in generating outputs 222 from corresponding sets of feature values 210).

For example, the component could analyze one or more distributions of data in training dataset 202 to determine confidence intervals, standard deviations, standard errors, variances, and/or other measures of data uncertainty associated with target values 212 of a dependent variable to be predicted using corresponding sets of feature values 210. The component could then store these measures of data uncertainty in the corresponding mappings within lookup table 204 to allow the measures of data uncertainty to be retrieved with the corresponding outputs 222 during lookup of lookup table 204. In another example, the component could store confidence scores, probabilities, and/or other measures of certainty generated by machine learning model 208 for various types of binary, categorical, and/or other discrete output 222. In a third example, the component could analyze outputs 222 produced by different versions of machine learning model 208 from the same sets of feature values 210 and/or quantized feature values 220. The component could then store standard deviations, variances, ranges of output 222 values, individual output 222 values, and/or other representations of uncertainty associated with output 222 produced by the different versions of machine learning model 208 in the corresponding mappings within lookup table 204.

Model quantization engine 124 performs dynamic variable quantization of weights, biases, activations, and/or other parameters 214 in machine learning model 208. More specifically, model quantization engine 124 quantizes parameters 214 of machine learning model 208 at different quantization resolutions to generate multiple quantized versions 224 of machine learning model 208. Model quantization engine 124 also generates a lookup table 206 that includes mappings between multiple sets of feature values 230(1)-(X) and version identifiers (IDs) 232(1)-(X) for quantized versions 224 of machine learning model 208 that can be used to generate the corresponding predictions. Consequently, mappings in lookup table 206 denote the selective operation of different quantized versions 224 of machine learning model 208 in generating predictions or output from corresponding sets of feature values 230.

To generate lookup table 206, model quantization engine 124 generates and/or retrieves multiple quantized versions 224(1)-(X) of machine learning model 208. For example, model quantization engine 124 could initially quantize parameters 214 of machine learning model 208 at a high quantization resolution (e.g., half-precision or single-precision floating point) to produce a first quantized version 224 of machine learning model 208. Model quantization engine 124 could iteratively lower the quantization resolution by a factor (e.g., a power of 2, a certain number of bits or bytes, etc.) to produce one or more additional quantized versions 224 of machine learning model 208. In another example, another component could generate quantized versions 224 of machine learning model 208, and model quantization engine 124 could retrieve quantized versions 224 from the other component, a repository, and/or another source.

Model quantization engine 124 also calculates one or more performance metrics 226(1)-(X) for each of quantized versions 224(1)-(X) and/or the full-precision machine learning model 208. For example, model quantization engine 124 could input sets of feature values in a test dataset (or another dataset available for machine learning model 208) into each version of machine learning model 208 and evaluate one or more performance metrics 226 for the version based on the prediction outputted by the version, the corresponding target value in the test dataset, the prediction outputted by the full-precision machine learning model 208, the efficiency of the version, and/or other factors. Thus, performance metrics 226 for a given quantized or unquantized version of machine learning model 208 could include a precision, recall, accuracy, mean absolute error (MAE), root mean squared error (RMSE), receiver operating characteristics (ROC), F-score, area under the curve (AUC), area under the receiver operating characteristics (AUROC), mean squared error (MSE), statistical correlation, mean reciprocal rank (MRR), peak signal-to-noise ratio (PSNR), inception score, structural similarity (SSIM) index, frechet inception distance, perplexity, intersection over union (IoU), observed/expected (O/E) ratio, and/or other measures of the ability of machine learning model 208 to predict target values in the test dataset (or the output of the full-precision machine learning model 208), given the corresponding sets of feature values. Performance metrics 226 could also, or instead, include an inference speed, training speed, memory footprint, power consumption, network bandwidth, and/or other measures of the resource consumption and/or efficiency of a given quantized or unquantized version of machine learning model 208.

Model quantization engine 124 then selects a default quantized version 228 of machine learning model 208 based on performance metrics 226 for multiple quantized versions 224 of machine learning model 208. In one or more embodiments, model quantization engine 124 selects default quantized version 228 as the quantized version of machine learning model 208 that achieves a highest overall performance metric (e.g., based on a weighted combination or aggregation of multiple performance metrics 226) across all quantized versions of machine learning model 208. Model quantization engine 124 also, or instead, selects default quantized version 228 as a quantized version with the lowest quantization resolution and/or lowest resource overhead that still achieves an overall predictive performance that falls within a threshold of the most accurate version of machine learning model 208.

For example, model quantization engine 124 could determine that initial quantization of machine learning model 208 to high quantization resolutions results in an increase in performance metrics 226 related to the predictive performance of machine learning model 208. This increase in predictive performance could correspond to an increased ability of machine learning model 208 to generalize to new data. As model quantization engine 124 evaluates performance metrics 226 for each quantized version of machine learning model 208, model quantization engine 124 tracks the version of machine learning model 208 that produces the best value for each individual performance metric and/or the best overall performance metric. These best performance metrics 226 could be used as one or more benchmarks for additional quantization of machine learning model 208, so that machine learning model 208 is further quantized to lower quantization resolutions until a given performance metric and/or the overall performance metric falls below a threshold from the corresponding benchmark. The lowest quantization resolution that results in the best overall performance metric (or a performance metric that falls within the threshold from the best overall performance metric) is then used to produce default quantized version 228.

After default quantized version 228 is selected, model quantization engine 124 stores an indication related to default quantized version 228 in lookup table 206. For example, model quantization engine 124 could include, in metadata and/or an entry in lookup table 206, a unique ID for default quantized version 228, a location of default quantized version 228, and/or other information that can be used to identify or retrieve default quantized version 228. Default quantized version 228 can then be applied to new sets of feature values that are not found in the training or test datasets, as described in further detail below.

Model quantization engine 124 also identifies the lowest quantization resolution that can be used to produce the correct output for a given set, range, or combination of feature values 230 in the test dataset. For example, model quantization engine 124 could compare the prediction produced by default quantized version 228 for various ranges or combinations of quantized or unquantized feature values 230 in the test dataset. When default quantized version 228 correctly predicts the target value (or output of the unquantized machine learning model 208) for a given range or combination of feature values, model quantization engine 124 gradually lowers the quantization resolution by a number of bites or bytes, a power of two, and/or another factor. Model quantization engine 124 then performs a comparison of the prediction produced by machine learning model 208 at each lowered quantization resolution with the corresponding target value (or output generated by the full-precision machine learning model 208 from the same feature values 230). Model quantization engine 124 discontinues the process once a quantized version of machine learning model 208 at a given quantization resolution generates a prediction that does not match the corresponding target value (or output generated by the full-precision machine learning model 208 from the same feature values 230).

Continuing with the above example, when default quantized version 228 incorrectly predicts the target value (or output generated by the unquantized machine learning model 208) for a given set, range, or combination of feature values 230, model quantization engine 124 could gradually increase the quantization resolution of quantized parameters 214 in machine learning model 208. Model quantization engine 124 compares the prediction produced by machine learning model 208 at each increased quantization resolution with the corresponding target value (or output generated by the unquantized machine learning model 208). Model quantization engine 124 discontinues the process once a given quantization resolution produces a prediction that matches the corresponding target value (or output generated by the full-precision machine learning model 208 from the same feature values 230). Thus, model quantization engine 124 finds the lowest quantization resolution at which machine learning model 208 is able to predict the corresponding target value (or output generated by the full-precision machine learning model 208 from the same feature values 230) for each set, range, or combination of feature values 230s.

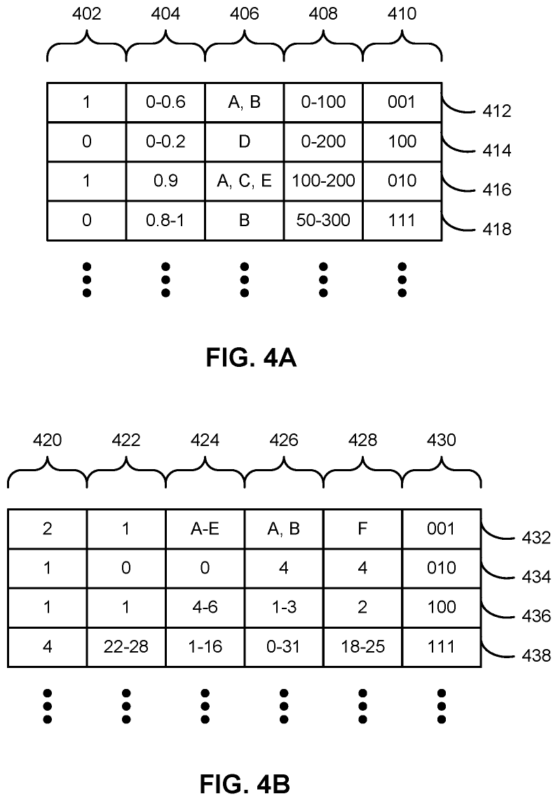

After model quantization engine 124 identifies the lowest quantization resolution at which machine learning model 208 produces a prediction that matches a target value (or output generated by the full-precision machine learning model 208 from the same feature values 230) for a given set, range, or combination of feature values 230, model quantization engine 124 stores, in lookup table 206, a mapping between those feature values 230 and version ID 232 of a given quantized version 224 at that quantization resolution. For example, model quantization engine 124 could store a mapping between a set, range, or combination of feature values 230 to one or more binary flags representing quantized version 224 to be used to generate the corresponding output. The mapping thus indicates the version of machine learning model 208 to be used with the set, range, or combination of feature values 230. Mappings in lookup table 206 are described in further detail below with respect to FIGS. 4A-4B.

In one or more embodiments, input quantization engine 122 and/or model quantization engine 124 include functionality to reduce the storage overhead and/or lookup speed associated with lookup tables 204 and/or 206 by storing mappings in lookup tables 204 and/or 206 in a compressed format. For example, input quantization engine 122 and/or model quantization engine 124 could store each field included in quantized feature values 220, output 222, feature values 230, version IDs 232, and/or other elements of lookup tables 204 and/or 206 using a minimum number of bits. Thus, a field that represents a binary feature value with possible values of 0 or 1 would be represented using a single bit, a field that stores one of four possible quantized values or one of four discrete categorical values would be represented using two bits, and a field that stores an unquantized feature value and/or an unquantized output could be represented using a single-precision, double-precision, extended-precision, quad-precision, and/or another type of floating-point representation. In another example, rows and/or columns in lookup tables 204 and/or 206 could be sorted, delta encoded, entropy encoded, dictionary encoded, or otherwise compressed, or stored using a high-speed lookup architecture to reduce the memory, storage footprint, and/or lookup time associated with the lookup table(s). In a third example, input quantization engine 122 could store mappings between quantized feature values 220 and a subset of possible target values or output (e.g., a value of 1 for a binary class outputted by machine learning model 208) in lookup table 204. When a given set of feature values cannot be mapped to a corresponding set of quantized feature values in lookup table 204, inference engine 126 could determine that the prediction associated with the set of feature values includes a target value or output that is omitted from lookup table 204 (e.g., a value of 0 for the binary class). In a fourth example, input quantization engine 122 and/or model quantization engine 124 could use feature selection techniques and a test dataset to analyze the relative impact of individual features or various subsets of features on the accuracy, inference speed, resource usage, and/or another measure of performance for a quantized and/or unquantized version of machine learning model 208. Input quantization engine 122 and/or model quantization engine 124 could identify a subset of features with greater than a threshold impact on machine learning model 208 output and/or performance (e.g., a fixed number of features with the highest performance impact and/or a variable number of features with a performance impact that exceeds a threshold). Input quantization engine 122 and/or model quantization engine 124 could then generate a corresponding lookup table (e.g., lookup table 204 and/or 206) so that only quantized feature values 220 and/or feature values 230 for the identified subset of features are stored in the lookup table, and quantized feature values 220 and/or feature values 230 for remaining features that have less than the threshold impact on machine learning model 208 output are omitted from the lookup table. Input quantization engine 122 and/or model quantization engine 124 could further select the number of quantized feature values 220 and/or feature values 230 stored in the lookup table based on the hardware capabilities of the device on which the lookup table is to be stored or used. Prior to generating the lookup table, input quantization engine 122 and/or model quantization engine 124 could verify that the omitted features result in the expected performance impact in machine learning model 208 (e.g., by executing machine learning model 208 using default values for the omitted features, etc.).

In some embodiments, dynamic variable quantization of machine learning model 208 performed by model quantization engine 124 is used in lieu of, or in addition to, the dynamic variable quantization of feature values 210 inputted into machine learning model 208 performed by input quantization engine 122. For example, model quantization engine 124 could quantize parameters 214 of machine learning model 208 when the operation of machine learning model 208 on all possible combinations of quantized feature values 220 cannot be represented using lookup table 204 and/or the number of features inputted into machine learning model 208 exceeds a threshold. In another example, machine learning model 208 could be represented using a combination of lookup tables 204 and 206. Within this representation, lookup table 204 could store mappings between quantized feature values 220 for a first subset of possible feature values (e.g., feature values 210 found in training dataset 202), and lookup table 206 could store mappings between quantized or unquantized feature values 230 for a second subset of possible feature values (e.g., feature values found in a test dataset) and version IDs 232 of quantized versions 224 of machine learning model 208 used to generate the corresponding output.

In some embodiments, input quantization engine 122 and/or model quantization engine 124 additionally include functionality to designate various combinations and/or ranges of quantized feature values 220 and/or feature values 230 in lookup tables 204 and/or 206 as adversarial or “out of bounds.” For example, input quantization engine 122 and/or model quantization engine 124 could store, in lookup tables 204 and/or 206, one or more mappings of “invalid” quantized feature values 220, feature values 230, and/or ranges or combinations of quantized or unquantized feature values to a reserved value indicating that machine learning model 208 cannot be used to perform inference using these quantized or unquantized feature values. When machine learning model 208 is used to predict atherosclerosis-based outcomes based on feature values related to attributes of human patients, these “invalid feature values could include an age that exceed 120 years, an age that falls below a threshold (e.g., five years) combined with a BMI that exceeds a threshold (e.g., 60), and/or a sex of male and a pregnancy status of “pregnant.” These invalid feature values can be provided by one or more domain experts or users associated with training dataset 202, specified in a set of rules, and/or determined by analyzing feature values 210 and/or target values 212 in training dataset 202 (e.g., identifying ranges or combinations of feature values 210 that result in “random,” “noisy,” or “nonsensical” output from machine learning model 208). Further, by identifying these invalid feature values in lookup tables 204 and/or 206, input quantization engine 122 and/or model quantization engine 124 can mitigate risk associated with adversarial attacks and/or prevent machine learning model 208 from generating output from these invalid feature values.

Inference engine 126 uses lookup table 204 generated by input quantization engine 122 and/or lookup table 206 generated by model quantization engine 124 to perform inference related to machine learning model 208 for one or more sets of feature values 240. For example, inference engine 126 could execute within an online, offline, nearline, streaming, search-based, and/or another type of environment to generate prediction 246 that includes or reflects predictions generated by machine learning model 208 from a given set of feature values 240.

More specifically, inference engine 126 performs a lookup of mappings in lookup table 204 and/or 206 using each set of feature values 240. After the lookup is complete, inference engine 126 receives lookup table results 242 related to the set of features. Inference engine 126 then uses lookup table results 242 to generate a prediction 246 representing inference by machine learning model 208 based on feature values 240.

For example, inference engine 126 could convert feature values 240 into one or more sets of quantized feature values at one or more quantization resolutions associated with quantized feature values 220 in lookup table 204. Next, inference engine 126 could perform a search of lookup table 204 using the set(s) of quantized feature values. When lookup table results 242 related to the search include a mapping of quantized feature values 220 that match a set of quantized feature values into which feature values 240 were converted, inference engine 126 could retrieve output 222 from the same mapping and use output 222 as prediction 246 generated by machine learning model 208 from feature values 240.

In another example, inference engine 126 could perform a search of lookup table 206 using feature values 240. This search of lookup table 206 could be performed in lieu of a search of lookup table 204 using the same feature values 240 (e.g., when lookup table 204 does not exist for machine learning model 208 or if inference engine 126 determines that lookup table 204 does not contain any mappings related to feature values 240). This search of lookup table 206 could alternatively be performed in addition to a search of lookup table 204 using the same feature values 240 (e.g., after a search of lookup table 204 using feature values 240 does not return any mappings). When lookup table results 242 related to the search of lookup table 206 include a mapping of feature values 230 that match feature values 240, inference engine 126 could use version ID 232 in the same mapping to retrieve a corresponding quantized version 224 of machine learning model 208. Inference engine 126 could then apply the retrieved quantized version 224 to feature values 240 to generate prediction 246.

In one or both of the above examples, when searches of lookup tables 204 and/or 206 using feature values 240 fail to return mappings that match feature values 240, inference engine 126 could retrieve a version ID for default quantized version 228 from metadata for lookup table 204 and/or 206. Inference engine 126 could then apply default quantized version 228 to feature values 240 to generate prediction 246 representing a corresponding prediction from machine learning model 208. Thus, one or both lookup tables 204 and/or 206 could be used to reduce the size, memory footprint, inference speed, and/or other types of resource consumption associated with executing machine learning model 208 without negatively impacting the accuracy of machine learning model 208.

After prediction 246 is generated or retrieved, inference engine 126 optionally performs additional processing related to prediction 246. For example, inference engine 126 could provide output 222 to another application, service or component; generate search results, recommendations, or other output based on one or more scores represented by prediction 246; and/or use prediction 246 in another machine learning or predictive context.

FIG. 3A illustrates an example lookup table 204 generated by input quantization engine 122 of FIG. 1, according to various embodiments. As shown in FIG. 3A, the example lookup table 204 includes a number of columns 302-310 and a number of rows 312-318. Each of rows 312-318 stores a mapping between four quantized feature values 220 in the first four columns 302-308 and a corresponding output 222 in the fifth column 310. As mentioned above, output 222 can be generated by machine learning model 208 from the four quantized feature values 220.

Consequently, each row represents the execution of machine learning model 208, after a set of quantized feature values 220 is inputted into machine learning model 208.

More specifically, each of quantized feature values 220 in columns 302-308 is quantized to a quantization resolution of four bits, or 16 possible values. Thus, each field in columns 302-308 includes a hexadecimal value that represents the quantized version of the corresponding feature value. The hexadecimal value can then be dequantized into a value that falls within the range of feature values 210 for the corresponding feature in training dataset 202 and/or another dataset for machine learning model 208.

Fields in the example lookup table 204 of FIG. 3A can additionally be stored and/or compressed to reduce the memory or storage overhead of lookup table 204. For example, the output of machine learning model 208 could include a binary value of 0 or 1 representing a predicted outcome related to different sets of feature values. This binary value could be stored in a single bit within lookup table 204 instead of in a byte, word, or another larger data size. In another example, lookup table 204 could include mappings between quantized feature values 220 and the outcome represented by 1 and omit any mappings between additional sets of quantized feature values 220 and the outcome represented by 0. Thus, any sets of quantized feature values that are not stored in lookup table 204 would correspond to the outcome represented by 0. In a third example, the memory or storage overhead of lookup table 204 could be reduced by omitting column 310 (when there is no ambiguity with respect to the output corresponding to each set of quantized feature values 220 in lookup table 204) and/or sorting, delta encoding, entropy encoding, dictionary encoding, or otherwise compressing or storing various rows 312-318, columns 302-310, and/or fields in lookup table 204.

To perform inference using the example lookup table 204 of FIG. 3A, inference engine 126 can convert each of four unquantized feature values 240 into one of 16 possible quantized feature values 240. Inference engine 126 can then perform a lookup of the example lookup table 204 using the quantized feature values 240. When inference engine 126 finds a match between the quantized feature values 240 and a corresponding set of quantized feature values 220 stored in the first four columns 302-308 and a given row of lookup table 204, inference engine 126 retrieves the corresponding output 222 from the fifth column 310 and the same row and uses output 222 as prediction 246 generated by machine learning model 208 from feature values 240.

When inference engine 126 fails to find a match between the quantized feature values 240 and a corresponding set of quantized feature values 220 in lookup table 204, inference engine 126 can apply a full-precision or default quantized version 228 of machine learning model 208 to the quantized or unquantized feature values 240 to generate prediction 246. Inference engine 126 can also, or instead, perform a search of lookup table 206 for a mapping that matches feature values 240. Alternatively, if lookup table 204 stores mappings between quantized feature values 220 and a subset of possible output 222 values from machine learning model 208 (e.g., a value of 1 for a binary output 222), inference engine 126 can determine that feature values 240 are associated with a different output value (e.g., a value of 0 for the same binary output 222) and set the different output value as prediction 246.

FIG. 3B illustrates an example lookup table 204 generated by input quantization engine 122 of FIG. 1, according to various embodiments. The example lookup table 204 of FIG. 3B includes multiple columns 320-330 and multiple rows 332-338. Unlike the example lookup table 204 of FIG. 3A, the example lookup table 204 of FIG. 3B includes quantized feature values 220 that are quantized to different quantization resolutions.

More specifically, within each row 332-338, columns 322-328 store quantized feature values 220 for four different features, column 320 stores a numeric value that is multiplied by 8 to obtain the number of quantization levels associated with quantized feature values 220, and column 330 stores a corresponding output 222 generated by machine learning model 208 from the four quantized feature values 220. Values in column 320 indicate that quantized feature values 220 in rows 332, 334, 336, and 338 are quantized to eight quantization levels, 32 quantization levels, 16 quantization levels, and 16 quantization levels, respectively. Values in column 330 indicate that quantized feature values 220 in all rows 332-338 are mapped to the same output 222 of 1. The four quantized feature values 220 in each row 332-338 can be dequantized into four values that fall within the ranges of feature values 210 for the corresponding features in training dataset 202 and/or another dataset for machine learning model 208.

To perform inference using the example lookup table 204 of FIG. 3A, inference engine 126 can determine the quantization resolutions associated with quantized feature values 220 in lookup table 204 by scanning values in column 320 and/or retrieving the quantization resolutions from metadata for lookup table 204. Next, inference engine 126 converts each of four unquantized feature values 240 into four quantized feature values 240 at one of the quantization resolutions (e.g., the lowest quantization resolution) and searches lookup table 204 for the quantized feature values 240. When inference engine 126 finds a match between the quantized feature values 240 and a corresponding set of quantized feature values 220 stored in columns 322-328 of a row of lookup table 204, inference engine 126 retrieves the corresponding output 222 from column 330 of the same row and uses output 222 as prediction 246 generated by machine learning model 208 from feature values 240. If inference engine 126 cannot find a match between quantized feature values 240 at a certain quantization resolution and a corresponding set of quantized feature values 220 in lookup table 204, inference engine 126 can generate a new set of quantized feature values 240 at a different quantization resolution (e.g., the next highest quantization resolution) and perform an additional search of lookup table 204 using the new set of quantized feature values 240.

Thus, inference engine 126 can perform searches of lookup table 204 using quantized feature values 240 at all quantization resolutions used to quantize feature values 210 in a dataset for machine learning model 208 until a corresponding set of quantized feature values 220 is found in lookup table 204. Alternatively, if inference engine 126 cannot find a match between quantized feature values 240 at any quantization resolution and a corresponding set of quantized feature values 220 in lookup table 204, inference engine 126 can apply a full-precision or default quantized version 228 of machine learning model 208 to the quantized or unquantized feature values 240 to generate prediction 246, perform a search of lookup table 206 for a mapping that matches feature values 240, and/or determine that feature values 240 have a different output value (e.g., a value of 0 for a binary output 222) than the output value stored in mappings of lookup table 204 (e.g., a value of 1 for a binary output 222).

Rows 332-338 can optionally be sorted to improve the speed with which searches of lookup table 204 are performed. For example, rows 332-338 could be sorted or grouped by increasing or decreasing quantization resolution to allow inference engine 126 to scan through a subset of mappings in lookup table 204 when matching quantized feature values 240 at a given quantization resolution to a corresponding set of quantized feature values 220 in lookup table 204. A given group of rows associated with the same quantization resolution could additionally be sorted by values in one or more columns 332-328 to increase the speed at which a set of quantized feature values 240 at the quantization resolution can be matched to a corresponding set of quantized feature values 220 in the group.

Lookup table 204 can additionally be adapted or incorporated into a variety of applications or use cases. First, lookup table 204 can be used as a replacement for the operation of some or all of machine learning model 208, as described above. Second, lookup table 204 can be used to analyze training dataset 202 and/or the operation or performance of machine learning model 208. For example, mappings in lookup table 204 could be compared with corresponding rows in training dataset 202 to determine the accuracy or performance of machine learning model 208 in predicting target values 212 in training dataset 202 and/or identify subsets of feature values 210 or quantized feature values 220 for which machine learning model 208 fails to predict the corresponding target values 212. In another example, mappings in lookup table 204 could be analyzed to assess bias in machine learning model 208. In a third example, mappings in lookup table 204 can be used to estimate the distribution of feature values 210 in training dataset 202, identify ranges and/or combinations of feature values 210 that are missing from training dataset 202, and/or evaluate the ability of machine learning model 208 to generalize to data outside of training dataset 202.

FIG. 4A illustrates an example lookup table 206 generated by model quantization engine 124 of FIG. 1, according to various embodiments. As shown in FIG. 4A, the example lookup table 206 includes a number of columns 402-410 and a number of rows 412-418. Each of rows 412-418 stores a mapping between feature values 230 for four features in the first four columns 402-408 and a three-bit flag in the fifth column 410 that identifies one of three quantized versions 224 of machine learning model 208 to be used to generate predictive output from feature values 230.

More specifically, fields in columns 402-408 store one or more feature values 230 for the four features. Each field in column 402 stores a binary value of 0 or 1 for a corresponding feature, each field in column 404 stores a specific value or a range of values for a second numeric feature, each field in column 406 stores one or more values for a categorical feature (e.g., a feature represented by categories A, B, C, D, E, etc.), and each field in column 408 stores a range of values for a fourth numeric feature.

Within each field of column 410, a bit that is set indicates that the corresponding quantized version of machine learning model 208 is to be applied to feature values that match the ranges and/or sets of values in the corresponding fields of columns 402-408. For example, the value of “001” stored in row 412 and column 410 could indicate that a quantized version of machine learning model 208 with the highest quantization resolution (out of three possible quantization resolutions) is to be used to generate predictive output for a value of 1 for the first feature represented by column 402, values ranging from 0 to 0.6 for the second feature represented by column 404, values of A and B for the third feature represented by column 406, and values ranging from 0 to 100 for the fourth feature represented by column 408. The value of “100” stored in row 414 and column 410 could indicate that a quantized version of machine learning model 208 with the lowest quantization resolution (out of three possible quantization resolutions) is to be used to generate predictive output for a value of 0 for the first feature represented by column 402, values ranging from 0 to 0.2 for the second feature represented by column 404, a value of D for the third feature represented by column 406, and values ranging from 0 to 200 for the fourth feature represented by column 408. The value of “010” stored in row 416 and column 410 could indicate that a quantized version of machine learning model 208 with the second highest quantization resolution (out of three possible quantization resolutions) is to be used to generate predictive output for a value of 1 for the first feature represented by column 402, a value of 0.9 for the second feature represented by column 404, values of A, C, and E for the third feature represented by column 406, and values ranging from 100 to 200 for the fourth feature represented by column 408.

On the other hand, a special code of “111” is stored in column 410 and row 418. This code may indicate that predictive output for a value of 0 for the first feature represented by column 402, values ranging from 0.8 to 1 for the second feature represented by column 404, a value of B for the third feature represented by column 406, and values ranging from 50 to 300 for the fourth feature represented by column 408 is to be generated using a default quantized version 228 of machine learning model 208, a full-precision version of machine learning model 208, a search of lookup table 204, and/or another action that does not involve one of the three quantized versions represented by individual bits in the flag.

Mappings of feature values 230 to version IDs 232 in the example lookup table 206 of FIG. 4A can be generated in a number of ways. As mentioned above, model quantization engine 124 could identify the lowest quantization resolution of machine learning model 208 that is able to predict the corresponding target value (or output generated by the unquantized machine learning model 208) for a given set, range, or combination of feature values. This set, range, or combination of feature values could be retrieved from training dataset 202, so that every set of feature values 210 in training dataset 202 can be matched to a corresponding row in lookup table 206. Ranges of values or multiple values for a given feature in a row of lookup table 206 could be determined by clustering or otherwise analyzing feature values 210 and/or target values 212 in training dataset 202 (e.g., identifying ranges or combinations of feature values 210 that result in similar accuracy from the same quantized version of machine learning model 208), specified by a domain expert or another user associated with training dataset 202, and/or determined by sampling or searching the space around feature values for one or more features (e.g., to determine a “region” around the feature value(s) that can be used with the same quantized version of machine learning model 208).

Fields in the example lookup table 206 of FIG. 4A can additionally be stored and/or compressed in ways that reduce the memory or storage overhead of lookup table 204. For example, the binary value of 0 or 1 in column 402 could be stored in a single bit within lookup table 204 instead of in a byte, word, or another larger data size. Similarly, each field in column 430 could be represented using three bits. In general, fields within each row or column of lookup table 206 could be stored using the least number of bits possible. Fields in lookup table 206 could also, or instead, be sorted, delta encoded, entropy encoded, dictionary encoded, or otherwise compressed.

Inference engine 126 can perform a lookup of the example lookup table 206 of FIG. 4A using a set of feature values 240. When inference engine 126 finds a match between feature values 240 and a corresponding set, range, or combination of feature values 230 stored in a row of lookup table 206, inference engine 126 retrieves the corresponding version ID 232 from the same row and applies the quantized version of machine learning model 208 represented by version ID 232 to feature values 240 to generate predictive prediction 246.

When inference engine 126 fails to find a match between feature values 240 and a corresponding set, range, or combination of feature values 220 in lookup table 206, inference engine 126 can apply a full-precision or default quantized version 228 of machine learning model 208 to feature values 240 to generate corresponding prediction 246. Inference engine 126 can also, or instead, perform a search of lookup table 204 for a mapping that matches feature values 240.

FIG. 4B illustrates an example lookup table 206 generated by model quantization engine 124 of FIG. 1, according to various embodiments. The example lookup table 206 of FIG. 4B includes multiple columns 420-430 and multiple rows 432-438. Unlike the example lookup table 206 of FIG. 4A, the example lookup table 206 of FIG. 4B includes quantized feature values 230 that are quantized to different quantization resolutions.

Within each row 432-438, columns 422-428 store quantized feature values 230 for four different features, column 420 stores a numeric value that is multiplied by 8 to obtain the number of quantization levels associated with quantized feature values 230, and column 430 stores a three-bit flag that identifies one of three quantized versions of machine learning model 208 and/or a code of “111” that indicates another action to be performed to generate predictive output from the corresponding feature values 230. Values in column 420 indicate that feature values 230 in rows 432, 434, 436, and 438 are quantized to 16 quantization levels, eight quantization levels, eight quantization levels, and 32 quantization levels, respectively.

To perform inference using the example lookup table 206 of FIG. 4B, inference engine 126 determines the quantization resolutions associated with quantized feature values 230 in lookup table 206 by scanning values in column 420 and/or retrieving the quantization resolutions from metadata for lookup table 206. Next, inference engine 126 converts each of four unquantized feature values 240 into four quantized feature values 240 at one of the quantization resolutions (e.g., the lowest quantization resolution) and searches lookup table 206 for the quantized feature values 240. When inference engine 126 finds a match between the quantized feature values 240 and a corresponding set of quantized feature values 230 stored in columns 422-428 of a row of lookup table 206, inference engine 126 retrieves the corresponding three-bit flag from column 430 of the same row and performs the action represented by the three-bit flag to generate prediction 246. If inference engine 126 cannot find a match between quantized feature values 240 at a certain quantization resolution and a corresponding set of quantized feature values 230 in lookup table 206, inference engine 126 can generate a new set of quantized feature values 240 at a different quantization resolution (e.g., the next highest quantization resolution) and perform an additional search of lookup table 206 using the new set of quantized feature values 240.

Thus, inference engine 126 can perform searches of lookup table 206 using quantized feature values 240 at all possible quantization resolutions used to quantize feature values 210 in a dataset for machine learning model 208 until a corresponding set of quantized feature values 230 is found. Alternatively, if inference engine 126 cannot find a match between quantized feature values 240 at varying quantization resolutions and a corresponding set of quantized feature values 230 in lookup table 206, inference engine 126 can apply a full-precision or default quantized version 228 of machine learning model 208 to the quantized or unquantized feature values 240 to generate prediction 246 and/or perform a search of lookup table 204 for a mapping that matches feature values 240.

Rows 432-438 can optionally be sorted to improve the speed with which searches of lookup table 206 are performed. For example, rows 432-438 could be sorted or grouped by increasing or decreasing quantization resolution to allow inference engine 126 to scan through a subset of mappings in lookup table 206 when matching quantized feature values 240 at a given quantization resolution to a corresponding set of quantized feature values 230 in lookup table 206. A given group of rows associated with the same quantization resolution could additionally be sorted by values in one or more columns 432-438 to increase the speed at which a set of quantized feature values 240 at the quantization resolution can be matched to a corresponding set, combination, or range of quantized feature values 230 in the group.

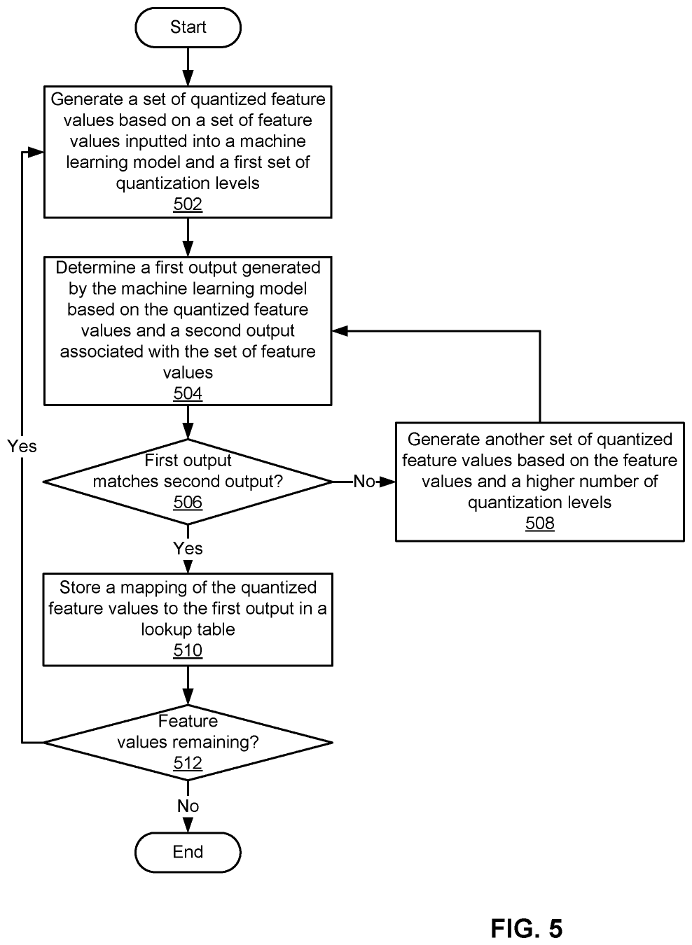

FIG. 5 sets forth a flow diagram of method steps for quantizing inputs into a machine learning model, according to various embodiments. Although the method steps are described in conjunction with the systems of FIGS. 1-2, persons skilled in the art will understand that any system configured to perform the method steps, in any order, is within the scope of the present invention.

As shown, input quantization engine 122 generates 502 a set of quantized feature values based on a set of feature values inputted into a machine learning model and a first set of quantization levels. For example, input quantization engine 122 could obtain the set of feature values from a training dataset and/or another dataset associated with the machine learning model. Input quantization engine 122 could then generate the quantized feature values by quantizing the set of feature values into a low number of quantization levels, such as 2, 4, or 8.

Next, input quantization engine 122 determines 504 a first output generated by the machine learning model based on the quantized feature values and a second output generated by the machine learning model based on the unquantized feature values. For example, input quantization engine 122 could apply the machine learning model to the quantized feature values and the feature values to generate the first output and the second output, respectively. Input quantization engine 122 could alternatively obtain the second output as a target value associated with the set of feature values from a training dataset.

Input quantization engine 122 then determines 506 whether or not the first output matches the second output. If the first output matches the second output (or differs from the second output by less than a threshold), input quantization engine 122 stores 510 a mapping of the quantized feature values to the first output in a lookup table.

If the first output does not match the second output (or differs from the second output by more than a threshold), input quantization engine 122 generates 508 another set of quantized feature values based on the set of feature values and a higher number of quantization levels. For example, input quantization engine 122 could produce the other set of quantized feature values by increasing the number of quantization levels with which the set of feature values is quantized by a multiple (e.g., 2) or an increment (e.g., a number of bits or bytes). Input quantization engine 122 then repeats operations 504-506 to determine whether or not the first output generated by the machine learning model based on the new set of quantized feature values matches the second output. Thus, input quantization engine 122 may perform operations 504-508 one or more times to identify the lowest quantization resolution required to produce a first output that matches (or is close enough to) the second output. Once this quantization resolution is identified, input quantization engine 122 performs operation 510 to store a mapping of the quantized feature values at the quantization resolution to the first output.

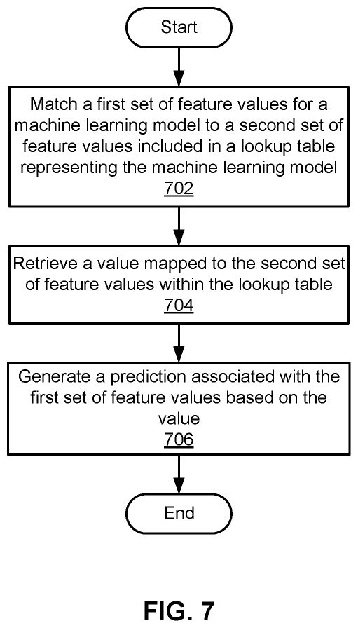

Input quantization engine 122 may repeat operations 502-510 for remaining feature values 512 in the training dataset and/or another dataset for the machine learning model. For example, input quantization engine 122 could determine the lowest quantization resolution at which a given set of feature values in the dataset can be quantized to produce a first output that matches the second output (e.g., the target value associated with the feature values and/or the output generated by the machine learning model from the unquantized feature values). Input quantization engine 122 could then populate the lookup table with a mapping between the quantized feature values and the first output. After input quantization engine 122 has performed operations 502-510 for all sets of feature values in the dataset, the lookup table can be used to perform inference related to the machine learning model, as described in further detail below with respect to FIG. 7.

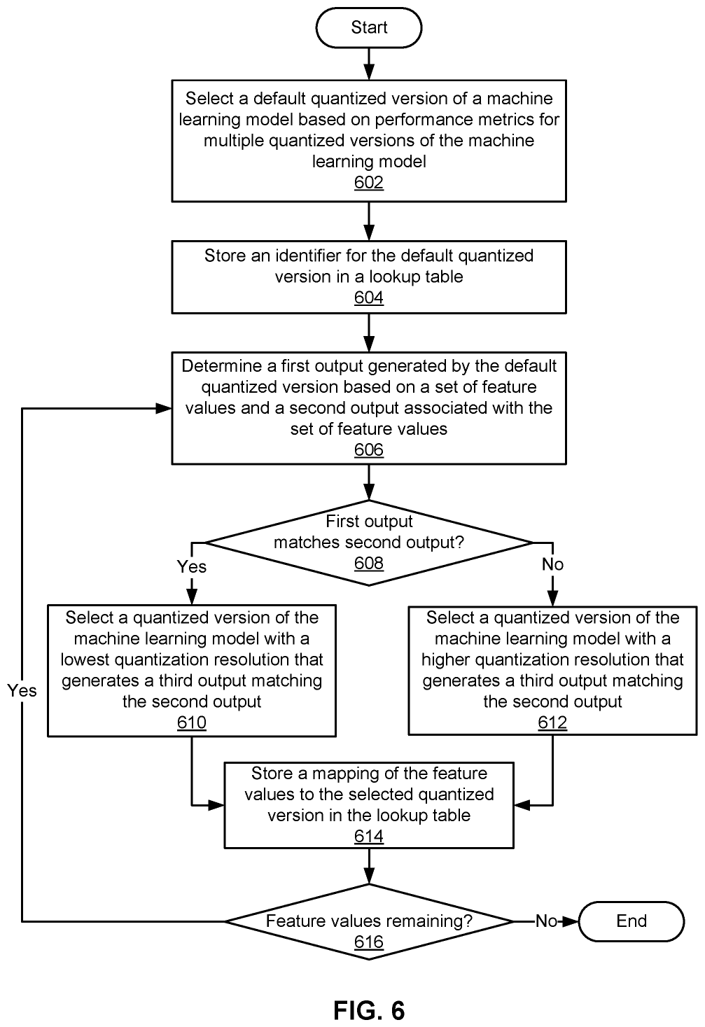

FIG. 6 sets forth a flow diagram of method steps for quantizing a machine learning model, according to various embodiments. Although the method steps are described in conjunction with the systems of FIGS. 1-2, persons skilled in the art will understand that any system configured to perform the method steps, in any order, is within the scope of the present invention.

As shown in FIG. 6, model quantization engine 124 selects 602 a default quantized version of a machine learning model based on a plurality of performance metrics for plurality of quantized versions of the machine learning model. For example, model quantization engine 124 could initially quantize weights, biases, activations, and/or other components of the machine learning model at a high quantization resolution (e.g., half-precision or single-precision floating point) to produce a first quantized version of the machine learning model 208. Model quantization engine 124 could iteratively lower the quantization resolution by a factor (e.g., a power of 2, a certain number of bits or bytes, etc.) to produce one or more additional quantized versions of the machine learning model 208. Model quantization engine 124 could then input sets of feature values in a test dataset (or another dataset available for the machine learning model) into each version of the machine learning model and evaluate one or more performance metrics for the version based on the prediction outputted by the quantized version, the corresponding target value in the test dataset, the prediction outputted by the unquantized version of the machine learning model, the efficiency with which the version of the machine learning model executes, and/or other factors. Finally, model quantization engine 124 could select the default quantized version as a quantized version of the machine learning model that has the best performance metric (or the best aggregation of multiple performance metrics) and/or as the quantized version with the lowest quantization resolution for which a performance metric falls within a threshold of the highest performance metric.

Model quantization engine 124 can also quantize different components of the machine learning level to different quantization levels. For example, model quantization engine 124 could perform operation 602 separately for weights, biases, and/or activations of a neural network. The weights and biases could be confined to the range of −1 to 1 and have 64 to 1024 quantization levels, and the activations could be confined to the range of 0 to 6 and quantized to a different number or range of quantization levels.

Model quantization engine 124 stores 604 an identifier for the default quantized version in a lookup table. For example, model quantization engine 124 could store a name, numeric identifier, path, and/or another representation of the default quantized version in metadata for the lookup table.

Next, model quantization engine 124 determines 606 a first output generated by the default quantized version based on a set of feature values and a second output associated with the set of feature values. For example, model quantization engine 124 could apply the default quantized version and the full-precision machine learning model to the feature values to generate the first output and the second output, respectively. Model quantization engine 124 could alternatively obtain the second output as a target value associated with the set of feature values from the dataset.

Model quantization engine 124 compares the first output with the second output to determine 606 whether or not the first output matches the second output. If the first output matches the second output (or differs from the second output by less than a threshold), model quantization engine 124 selects 608 a quantized version of the machine learning model with a lowest quantization resolution that generates a third output matching the second output. For example, model quantization engine 124 could gradually lower the quantization resolution of the machine learning model until a given quantization resolution results in a third output that does not match the second output. Model quantization engine 124 then selects the quantized version associated with the next highest quantization resolution as the quantized version with the lowest quantization resolution that generates a third output matching the second output.

If the first output does not match the second output (or differs from the second output by more than a threshold), model quantization engine 124 selects 612 a quantized version of the machine learning model with a higher quantization resolution that generates a third output matching the second output. For example, model quantization engine 124 could gradually increase the quantization resolution of the machine learning model. Model quantization engine 124 could compare the third output produced by the machine learning model at each increased quantization resolution with the second output. Model quantization engine 124 then selects the quantized version with the next highest quantization resolution that produces the third output that matches the second output.

After model quantization engine 124 selects a quantized version of the machine learning model in operation 610 or 612, model quantization engine 124 stores a mapping between the feature values to the selected quantized version in the lookup table. For example, model quantization engine 124 could store a mapping between a set, range, or combination of feature values to one or more binary flags representing the quantized version to be used to generate the corresponding output.

Model quantization engine 124 may repeat operations 602-614 for remaining feature values 616 in the dataset. For example, model quantization engine 124 could determine, for each set, range, or combination of feature values, the lowest quantization resolution at which the machine learning model produces a third output that matches the second output (e.g., the target value associated with the feature values and/or the output generated by the machine learning model from the unquantized feature values). Model quantization engine 124 could then populate the lookup table with a mapping between the feature values and a representation of the quantized version at the quantization resolution. After model quantization engine 124 has performed operations 602-614 for all sets of feature values in the dataset, the lookup table can be used to perform inference related to the machine learning model, as described in further detail below with respect to FIG. 7.

FIG. 7 sets forth a flow diagram of method steps for performing inference related to a machine learning model, according to various embodiments. Although the method steps are described in conjunction with the systems of FIGS. 1-2, persons skilled in the art will understand that any system configured to perform the method steps, in any order, is within the scope of the present invention.

As shown, inference engine 126 matches 702 a first set of feature values for a machine learning model to a second set of feature values included in a lookup table representing the machine learning model. In a first example, inference engine 126 could convert the first set of feature values into one or more sets of quantized feature values at one or more quantization resolutions associated with quantized feature values stored in the lookup table. Next, inference engine 126 could perform a search of the lookup table using the set(s) of quantized feature values and identify a matching set of quantized values within the lookup table. In a second example, inference engine 126 could perform a search of another lookup table using the first set of feature values and identify a range, combination, or set of feature values to which the first set of feature values belongs.

Next, inference engine 126 retrieves 704 a value mapped to the second set of feature values within the lookup table. Continuing with the first example, inference engine 126 could retrieve an output generated by the machine learning model from the second set of feature values from a mapping that includes the second set of feature values. Continuing with the second example, inference engine 126 could retrieve an identifier for a quantized version of the machine learning model from a mapping that includes the second set of feature values.

Inference engine 126 then generates 706 a prediction associated with the first set of feature values based on the value. Continuing with the first example, inference engine 126 could use the output in the mapping as the prediction generated by the machine learning model from the first set of feature values. Continuing with the second example, inference engine 126 could use the identifier to retrieve the corresponding quantized version of the machine learning model. Inference engine 126 could then apply the quantized version to the first set of feature values to generate a prediction.

In one or both of the above examples, when the first set of feature values cannot be matched to a second set of feature values in one or more lookup tables, inference engine 126 could retrieve an identifier fora default quantized version of the machine learning model from metadata for the lookup table(s). Inference engine 126 could then apply the default quantized version to the first set of feature values to generate output representing a corresponding prediction from the machine learning model.

In sum, the disclosed techniques perform dynamic variable quantization of inputs, weights, biases, activations, and/or other components of a machine learning model. When the number of features inputted into the machine learning model falls below a threshold (e.g., a maximum of 10 features), each feature can be quantized (e.g., divided, bucketized, binned, etc.) into a low number of discrete values. Each set of feature values from a training dataset can then be quantized in this manner, and the machine learning model can be used to generate a prediction from the set of quantized feature values. When the machine learning model predicts the wrong target value for a given row in the training data, feature values in the row are split into a higher number of bucketized values until the output generated by the machine learning model from the bucketized values matches the target value for the row (or the output generated by the machine learning model from the corresponding unquantized values) and/or a threshold level of quantization is reached. Variable-resolution quantized feature values and the corresponding target values (or machine learning model output) can then be stored in a lookup table representing the machine learning model. The lookup table thus includes mappings of most or all sets of feature values in the training dataset to the corresponding target values. Within the lookup table, a given set of feature values is represented using the lowest granularity that results in a correct prediction by the machine learning model.

When the number of features inputted into the machine learning model exceeds the threshold, dynamic variable quantization can be applied to weights, biases, and/or activations in the machine learning model. In this approach, the machine learning model includes an initial state with weights and biases that are quantized to a high quantization resolution, such as single- or double-precision floating point. The quantization resolution is gradually lowered by a factor (e.g., a power of 2, a certain number of bits or bytes, etc.), and a performance metric (e.g., precision, recall, accuracy, TP rate, FP rate, ROC, AUC, RMSE, etc.) is calculated for the machine learning model at each quantization level. As the machine learning model is gradually quantized, the performance metric can increase to reflect the ability of the machine learning model to generalize to new data. The highest performance metric calculated for the machine learning model is then used as a benchmark for additional quantization resolutions for the machine learning model, and the machine learning model is further quantized until the performance metric falls below a threshold. The lowest quantization resolution that results in the best overall performance metric (or a performance metric that still meets the threshold) is then used to produce a “default” quantized version of the machine learning model. This default quantized version can then be applied to new sets of feature values that are not found in the training dataset (e.g., during testing, validation, or inference).

Quantization resolutions in the machine learning model can additionally be adapted to different sets, ranges, and/or combinations of feature values in a test dataset. More specifically, the test accuracy, inference speed, or another measure of performance for the quantized machine learning model is evaluated at different quantization resolutions for various ranges, combinations, or sets of feature values in a test dataset (which can be quantized or unquantized). When a quantized version of the machine learning model associated with a given quantization resolution results in a correct prediction for a range, combination, or set of feature values, the quantization resolution is gradually lowered to find the lowest quantization resolution of the machine learning model that produces the correct prediction for that range, combination, or set of feature values. When a quantized version of the machine learning model associated with a given quantization resolution results in an incorrect prediction for a range, combination, or set of feature values, the quantization resolution is increased until the machine learning model produces a correct prediction for that range, combination, or set of feature values. The range, combination, or set of feature values can then be mapped to the quantization resolution in a different lookup table.

Quantization of features can also be mixed with quantization of the machine learning model to produce an inference strategy that is both computationally efficient and accurate. For example, sets of feature values in the training dataset for the machine learning model could be dynamically quantized and used to populate a lookup table. Feature values in the test dataset for the machine learning model could also be mapped to different quantization levels for weights and biases in the neural network. During inference, when a set of feature values matches a quantized set of feature values in the training dataset, a prediction for the new set of features could be generated by retrieving the target value for the quantized set of features from the lookup table. When a set of features matches a range, combination, or set of features that is mapped to a quantization resolution associated with the machine learning model, the quantized version of the machine learning model at the quantization resolution is used to generate a prediction for the new set of features. When a set of features does not match any quantized feature values in the training dataset or any range, set, or combination of features in the test dataset, the default quantized version of the machine learning model is used to generate a prediction for that set of features.

One technical advantage of the disclosed techniques relative to the prior art is that the inference speed, memory footprint, and computational overhead of the machine learning model are reduced without impacting the accuracy of the machine learning model. Another advantage of the disclosed techniques is the selection of a default quantized version of the machine learning model that executes more efficiently and is more generalizable than the full-precision machine learning model. Another advantage of the disclosed techniques is the ability to adapt the quantization of the machine learning model to different numbers and/or types of features, target values to be predicted from the features, target hardware platforms, and/or latency requirements. A further advantage of the disclosed techniques is the ability to mitigate adversarial attacks or assess uncertainty associated with machine learning outputs during machine learning inference. These technical advantages provide one or more technological improvements over prior art approaches.

1. In some embodiments, a computer-implemented method for quantizing a machine learning model comprises selecting a default quantized version of the machine learning model based on a plurality of performance metrics for a plurality of quantized versions of the machine learning model, determining that a first output generated by the default quantized version based on a first set of feature values does not match a second output associated with the first set of feature values, and storing a first mapping of one or more first feature values included in the first set of feature values to a first quantized version of the machine learning model in a lookup table representing the machine learning model, wherein the first quantized version is associated with a higher quantization resolution than the default quantized version.

2. The computer-implemented method of clause 1, further comprising determining that a third output generated by the first quantized version based on the first set of feature values matches the second output prior to storing the first mapping in the lookup table.

3. The computer-implemented method of clauses 1 or 2, wherein the first quantized version is selected to have a lowest quantization resolution among a subset of the plurality of quantized versions of the machine learning model that generates the third output based on the first set of feature values.

4. The computer-implemented method of any of clauses 1-3, further comprising determining that a third output generated by the default quantized version based on a second set of feature values matches a fourth output associated with the second set of feature values, selecting a second quantized version of the machine learning model that generates the third output based on the second set of feature values, wherein the second quantized version is associated with a lower quantization resolution than the default quantized version, and storing a second mapping of one or more second feature values included in the second set of feature values to the second quantized version in the lookup table.

5. The computer-implemented method of any of clauses 1-4, wherein the second quantized version is selected to have a lowest quantization resolution among a subset of the plurality of quantized versions of the machine learning model that generates the third output based on the second set of feature values.

6. The computer-implemented method of any of clauses 1-5, further comprising determining that a second set of feature values for the machine learning model is not stored in the lookup table, and applying the default quantized version to the second set of feature values to produce a third output.

7. The computer-implemented method of any of clauses 1-6, wherein selecting the default quantized version comprises determining that the default quantized version has a highest performance metric within the plurality of performance metrics.

8. The computer-implemented method of any of clauses 1-7, wherein selecting the default quantized version comprises determining that the default quantized version has a performance metric that is within a threshold of a highest performance metric included in the plurality of performance metrics.

9. The computer-implemented method of any of clauses 1-8, wherein the one or more first feature values included in the first mapping comprise at least one of a range of feature values, a quantized feature value, or multiple feature values for a single feature.

10. The computer-implemented method of any of clauses 1-9, wherein the second output comprises at least one of a label associated with the first set of feature values or an output generated by the machine learning model based on the first set of feature values.

11. In some embodiments, one or more non-transitory computer readable media store instructions that, when executed by one or more processors, cause the one or more processors to perform the steps of selecting a default quantized version of a machine learning model from a plurality of quantized versions of the machine learning model based on a plurality of performance metrics for the plurality of quantized versions, determining that a first output generated by the default quantized version based on a first set of feature values matches a second output associated with the first set of feature values, and storing a first mapping of one or more first feature values included in the first set of feature values to a first quantized version of the machine learning model in a lookup table representing the machine learning model, wherein the first quantized version is associated with a lower quantization resolution than the default quantized version.

12. The one or more non-transitory computer readable media of clause 11, wherein the instructions further cause the one or more processors to perform the step of determining that a third output generated by the first quantized version based on the first set of feature values matches the second output prior to storing the first mapping in the lookup table.

13. The one or more non-transitory computer readable media of clauses 11 or 12, wherein the first quantized version is selected to have a lowest quantization resolution among a subset of the plurality of quantized versions of the machine learning model that generates the third output based on the first set of feature values.

14. The one or more non-transitory computer readable media of any of clauses 11-13, wherein the instructions further cause the one or more processors to perform the steps of determining that a third output generated by the default quantized version based on a second set of feature values does not match a fourth output associated with the second set of feature values, selecting a second quantized version of the machine learning model that generates the fourth output based on the second set of feature values, wherein the second quantized version is associated with a higher quantization resolution than the default quantized version, and storing a second mapping of one or more second feature values included in the second set of feature values to the second quantized version in the lookup table.

15. The one or more non-transitory computer readable media of any of clauses 11-14, wherein the instructions further cause the one or more processors to perform the steps of determining that a third output generated by the default quantized version based on a second set of feature values matches a fourth output associated with the second set of feature values, and storing a second mapping of one or more second feature values included in the second set of feature values to the default quantized version in the lookup table.

16. The one or more non-transitory computer readable media of any of clauses 11-15, wherein selecting the default quantized version comprises determining that the default quantized version has a performance metric that is within a threshold of a highest performance metric included in the plurality of performance metrics.

17. The one or more non-transitory computer readable media of any of clauses 11-16, wherein the one or more first feature values included in the first mapping comprise at least one of a range of feature values, a quantized feature value, or multiple feature values for a single feature.

18. In some embodiments, a computer-implemented method for performing inference associated with a machine learning model comprises matching a first set of feature values for the machine learning model to a second set of feature values included in a lookup table representing the machine learning model, wherein the lookup table comprises a plurality of mappings between a plurality of sets of feature values to a plurality of identifiers for a plurality of quantized versions of the machine learning model, retrieving a first identifier that is mapped to the second set of feature values within the lookup table, and applying a first quantized version of the machine learning model that corresponds to the first identifier to the first set of feature values to generate a prediction associated with the first set of feature values.

19. The computer-implemented method of clause 18, wherein the plurality of sets of feature values included in the lookup table comprise at least one of a range of feature values, a quantized feature value, or multiple feature values for a single feature.

20. The computer-implemented method of clauses 18 or 19, wherein the lookup table further comprises a second identifier for a default quantized version of the machine learning model.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for quantizing a machine learning model, the method comprising:
selecting a default quantized version of the machine learning model based on a plurality of performance metrics for a plurality of quantized versions of the machine learning model;
determining that a first output generated by the default quantized version based on a first set of feature values does not match a second output associated with the first set of feature values; and
storing a first mapping of one or more first feature values included in the first set of feature values to a first quantized version of the machine learning model in a lookup table representing the machine learning model, wherein the first quantized version is associated with a higher quantization resolution than the default quantized version.

2. The computer-implemented method of claim 1, further comprising determining that a third output generated by the first quantized version based on the first set of feature values matches the second output prior to storing the first mapping in the lookup table.

3. The computer-implemented method of claim 2, wherein the first quantized version is selected to have a lowest quantization resolution among a subset of the plurality of quantized versions of the machine learning model that generates the third output based on the first set of feature values.

4. The computer-implemented method of claim 1, further comprising:
determining that a third output generated by the default quantized version based on a second set of feature values matches a fourth output associated with the second set of feature values;
selecting a second quantized version of the machine learning model that generates the third output based on the second set of feature values, wherein the second quantized version is associated with a lower quantization resolution than the default quantized version; and
storing a second mapping of one or more second feature values included in the second set of feature values to the second quantized version in the lookup table.

5. The computer-implemented method of claim 4, wherein the second quantized version is selected to have a lowest quantization resolution among a subset of the plurality of quantized versions of the machine learning model that generates the third output based on the second set of feature values.

6. The computer-implemented method of claim 1, further comprising:
determining that a second set of feature values for the machine learning model is not stored in the lookup table; and
applying the default quantized version to the second set of feature values to produce a third output.

7. The computer-implemented method of claim 1, wherein selecting the default quantized version comprises determining that the default quantized version has a highest performance metric within the plurality of performance metrics.

8. The computer-implemented method of claim 1, wherein selecting the default quantized version comprises determining that the default quantized version has a performance metric that is within a threshold of a highest performance metric included in the plurality of performance metrics.

9. The computer-implemented method of claim 1, wherein the one or more first feature values included in the first mapping comprise at least one of a range of feature values, a quantized feature value, or multiple feature values for a single feature.

10. The computer-implemented method of claim 1, wherein the second output comprises at least one of a label associated with the first set of feature values or an output generated by the machine learning model based on the first set of feature values.

11. One or more non-transitory computer readable media storing instructions that, when executed by one or more processors, cause the one or more processors to perform the steps of:
selecting a default quantized version of a machine learning model from a plurality of quantized versions of the machine learning model based on a plurality of performance metrics for the plurality of quantized versions;
determining that a first output generated by the default quantized version based on a first set of feature values matches a second output associated with the first set of feature values; and
storing a first mapping of one or more first feature values included in the first set of feature values to a first quantized version of the machine learning model in a lookup table representing the machine learning model, wherein the first quantized version is associated with a lower quantization resolution than the default quantized version.

12. The one or more non-transitory computer readable media of claim 11, wherein the instructions further cause the one or more processors to perform the step of determining that a third output generated by the first quantized version based on the first set of feature values matches the second output prior to storing the first mapping in the lookup table.

13. The one or more non-transitory computer readable media of claim 12, wherein the first quantized version is selected to have a lowest quantization resolution among a subset of the plurality of quantized versions of the machine learning model that generates the third output based on the first set of feature values.

14. The one or more non-transitory computer readable media of claim 11, wherein the instructions further cause the one or more processors to perform the steps of:
determining that a third output generated by the default quantized version based on a second set of feature values does not match a fourth output associated with the second set of feature values;
selecting a second quantized version of the machine learning model that generates the fourth output based on the second set of feature values, wherein the second quantized version is associated with a higher quantization resolution than the default quantized version; and
storing a second mapping of one or more second feature values included in the second set of feature values to the second quantized version in the lookup table.

15. The one or more non-transitory computer readable media of claim 14, wherein the instructions further cause the one or more processors to perform the steps of:
determining that a third output generated by the default quantized version based on a second set of feature values matches a fourth output associated with the second set of feature values; and
storing a second mapping of one or more second feature values included in the second set of feature values to the default quantized version in the lookup table.

16. The one or more non-transitory computer readable media of claim 11, wherein selecting the default quantized version comprises determining that the default quantized version has a performance metric that is within a threshold of a highest performance metric included in the plurality of performance metrics.

17. The one or more non-transitory computer readable media of claim 11, wherein the one or more first feature values included in the first mapping comprise at least one of a range of feature values, a quantized feature value, or multiple feature values for a single feature.

18. A computer-implemented method for performing inference associated with a machine learning model, the method comprising:
matching a first set of feature values for the machine learning model to a second set of feature values included in a lookup table representing the machine learning model, wherein the lookup table comprises a plurality of mappings between a plurality of sets of feature values to a plurality of identifiers for a plurality of quantized versions of the machine learning model;
retrieving a first identifier that is mapped to the second set of feature values within the lookup table; and
applying a first quantized version of the machine learning model that corresponds to the first identifier to the first set of feature values to generate a prediction associated with the first set of feature values.

19. The computer-implemented method of claim 18, wherein the plurality of sets of feature values included in the lookup table comprise at least one of a range of feature values, a quantized feature value, or multiple feature values for a single feature.

20. The computer-implemented method of claim 18, wherein the lookup table further comprises a second identifier for a default quantized version of the machine learning model.
